(19) United States
(12) Patent Application Publication
(10) Pub. No.: US 2006/0086767 A1
(43) Pub. Date: Apr. 27, 2006

(54) Stanchion assembly

(75) Inventors: John H. Harberts, Macomb, MI (US); Bruce A. Handrinos, Clinton Township, MI (US); John E. Klinkman, Riley Township, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: SportRack LLC, Sterling Heights, MI (US)

(21) Appl. No.: 11/230,170

(22) Filed: Sep. 19, 2005

Related U.S. Application Data
(60) Provisional application No. 60/611,894, filed on Sep. 21, 2004.

(51) Int. Cl. B60R 9/00

(52) U.S. Cl. 224/329

(57) ABSTRACT

A stanchion assembly attached to a vehicle for an article rack includes a support, a cover, and a support flange for connecting the stanchion to a side bar. The support flange is constructed of a higher strength material than the support or the cover to provide a stanchion that reduces weight and is less expensive while providing adequate support for the article rack.

### CROSS REFERENCE TO RELATED APPLICATION

This application claims the benefit of Provisional Application 60/611,894, filed on Sep. 21, 2004, the contents of which are hereby incorporated by reference herein in their entirety.

### FIELD OF THE INVENTION

The present invention is generally directed to a luggage carrier or article rack assembly selectively mounted to an outer body surface of a vehicle, and more specifically to a stanchion assemblies for side rails of these assemblies.

### BACKGROUND OF THE INVENTION

Luggage carriers or article rack assemblies are used in a variety of applications to transport articles above an outer body surface of a vehicle. Such article carriers may include a pair of elevated side bars that are fixed to the outer body surface of a vehicle with a plurality of stanchions. In many applications, crossbars extend between the side bars. A crossbar may be fixed to the side bars or adjustably secured via its own pair of bracket members disposed slidably upon the side bars. In addition to crossbars, other cross assemblies may be attached to the article rack for stowing or securing desired articles.

Each stanchion associated with a side bar includes some form of coupling mechanism for attaching the side bar to the vehicle. Additionally, a coupling mechanism is required between the crossbar and the side bar. For various reasons, some stanchions are constructed entirely of more expensive, high-strength materials.

Unfortunately, this arrangement often requires a costly stanchion manufactured of selected materials to withstand the loadings experienced in normal use. At least part of this cost is due to cost of the materials, and the amount of material and time required to construct the completed stanchion.

Accordingly, an improved luggage carrier or article rack assembly manufactured of less expensive components is desired. It would further be highly desirable to provide such an assembly with components that are easy to assemble and provide additional flexibility for various interchangeable cross assemblies.

### SUMMARY OF THE INVENTION

An embodiment of the present invention provides a stanchion of an article rack assembly for attaching a side bar to a vehicle. The stanchion includes a support, The support is selectively attached to the vehicle and the side bar. The stanchion also includes a cover adjacent said support and the side bar, wherein said cover is selectively adapted to bindingly clip into a desired attachment with the side bar. The stanchion further includes a support flange. The support flange is adjacent the side bar and selectively coupled to the cover, the side bar and a cross assembly. The support flange is constructed of a higher strength material than the support and the cover.

Another embodiment includes article rack assembly for a vehicle. The article rack assembly includes a side bar and a support. The support is selectively attached to the vehicle and adjacent the side bar. The article rack assembly also includes a cover adjacent the support and the side bar. The article rack assembly further includes a support flange. The support flange is adjacent the side bar and selectively attached to the support and to the cover. The support flange is selectively coupled to a cross assembly. The support flange is constructed of a higher strength material than the support. At least the support, the cover, and the support flange form a front stanchion.

Yet a further embodiment includes method of assembling a stanchion for an article rack assembly. The method includes the step of bindingly clipping a cover to a first end of a side bar. The side bar has a bend adjacent the first end and the cover contacts at least more than 180° of a cross section of the side bar. The method also includes positioning the cover and the side bar adjacent a support. The support is selectively coupled to the side bar. The method further includes coupling a support flange to the side bar.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of an embodiment of the side bar assembly of the present invention showing the side bar and stanchions.

FIG. 2 is a perspective view of the side bar of FIG. 1, taken from approximately the same viewpoint as FIG. 1.

FIG. 3 is a perspective view of the stanchion support of FIG. 1, taken from a different viewpoint as FIG. 1, for clarity.

FIG. 4 is a perspective view of the stanchion support flange of FIG. 1, taken from approximately the same viewpoint as FIG. 1.

FIG. 5 is a perspective view of the stanchion cover of FIG. 1, taken from approximately the same viewpoint as FIG. 1.

FIG. 6 is an enlarged cross-section of the side bar assembly taken along line 6-6 of FIG. 1.

FIG. 7 is a perspective view of an embodiment of a cross assembly for mounting to the side bar assembly of FIG. 1.

FIG. 8 is a side view of the cross assembly of FIG. 7.

FIG. 9 is a perspective view of a cover for the cross assembly of FIG. 7.

FIG. 10 is an embodiment of an air dam for use with side bar assemblies of the present invention.

### DETAILED DESCRIPTION OF THE INVENTION

Referring now to the drawings, the preferred illustrative embodiments of the present invention are shown in detail. Although the drawings represent some preferred embodiments of the present invention, the drawings are not necessarily to scale and certain features may be exaggerated to better illustrate and explain the present invention. Further, the embodiments set forth herein are not intended to be exhaustive or otherwise limit or restrict the invention to the precise forms and configurations shown in the drawings and disclosed in the following detailed description.

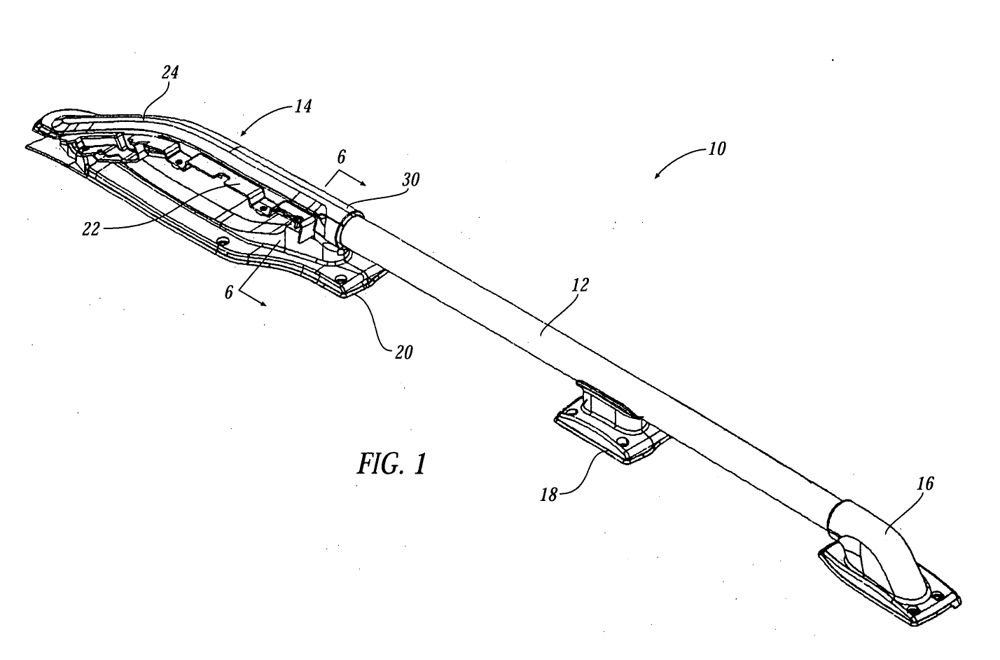

With reference to FIG. 1, an embodiment of a side bar assembly 10 includes a side bar 12, a front stanchion 14, a rear stanchion 16, and a mid support 18. Front stanchion 14 is illustrated to include a support 20, a support flange 22, and a cover 24.

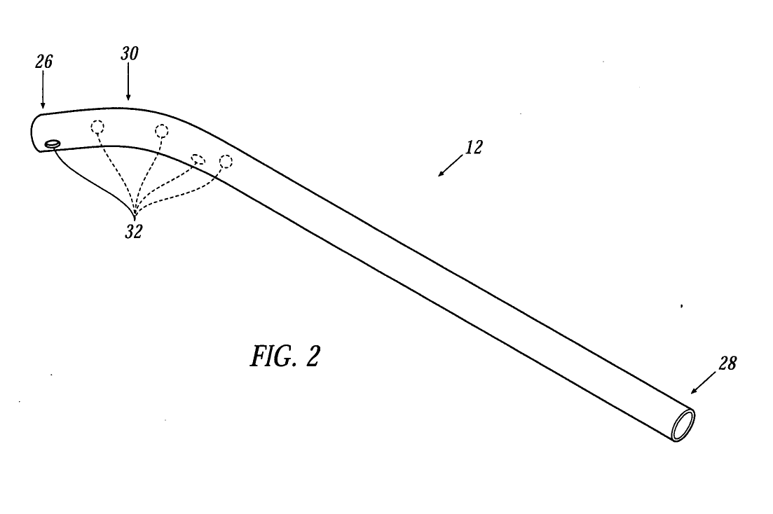

FIG. 2 illustrates side bar 12 as a tubular, generally circular member including a front stanchion end 26 and a rear stanchion end 28 with a curved portion 30 and attachment apertures 32 formed therein. In the disclosed embodiment, attachment apertures 32 are along a side surface of side bar 12, but are not limited to this location. As discussed below, curved portion 30 is interposed within front stanchion 14.

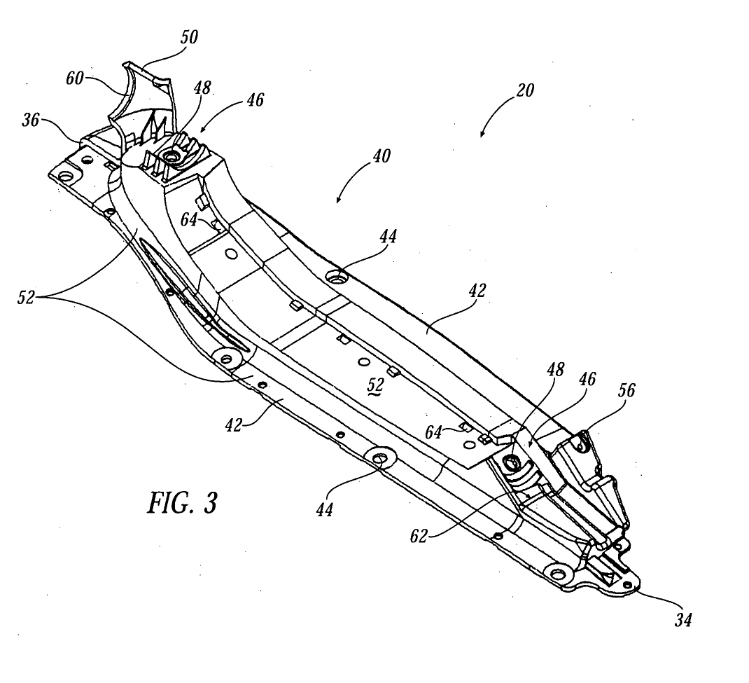

Referring now to FIG. 3, support 20 is illustrated to include a forward end 34 and a rearward end 36 with a body portion 40 extending therebetween. The body portion 40 includes a base 42 with mounting apertures 44 formed therein. The body portion 40 further includes cradles 46 for supporting side bar 12 (not shown) and connecting apertures 48 for connecting support 20 to side bar 12, as discussed below. Support 20 is further illustrated to include a cover portion 50, a cover mating surface 52, and a flange mount 56. Cover portion 50 includes a side bar surface mating portion 60. The cradle 46 adjacent forward end 34 includes an abutting surface 62 that extends about perpendicular to a surface of the cradle 46. Cover mating surface 52 includes indents 64 formed therein.

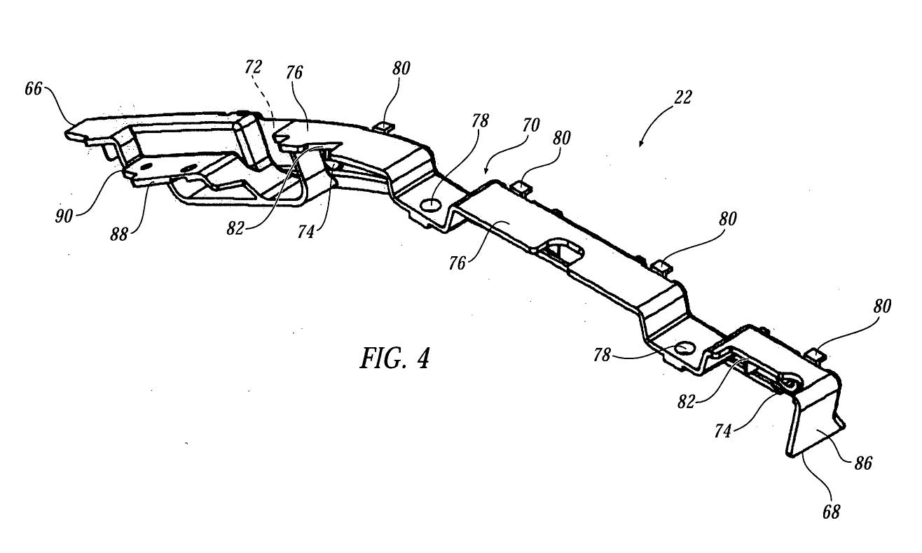

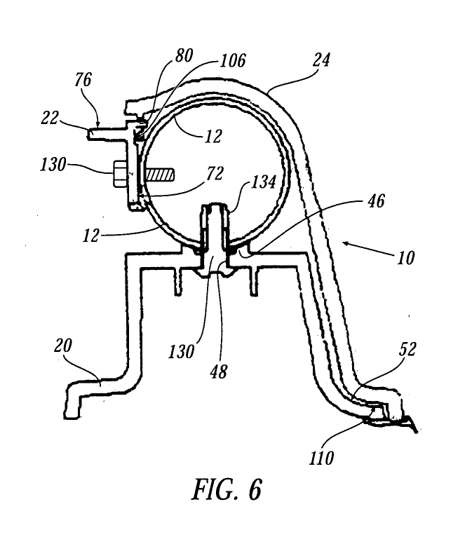

With reference to FIG. 4, an embodiment of support flange 22 is illustrated to include a front end 66 and a rear end 68 with a curved body 70 extending therebetween. The curved body 70 is generally complementary to curved portion 30. The curved body 70 is defined, at least in part, by a side surface 72 with a plurality of side bar apertures 74 formed therein, and a cross surface 76, which includes a plurality of cross apertures 78 formed therein. Curved body 70 further includes a pair of alignment surface locations 82 that intersect cross surface 76 and define an extending side of curved body 70 for mating with a cross assembly, as described in greater detail below. Support flange 22 is illustrated to further include cover tabs 80 extending therefrom, a perpendicular rib 86, and a body brace 88 which defines a flange aperture 90. Side surface 72 is best illustrated in FIG. 6 as contoured to securely abut side bar 12 during assembly of side bar assembly 10. As discussed below, cross surface 76 is contoured to mate with an attaching surface of a cross assembly, as discussed below.

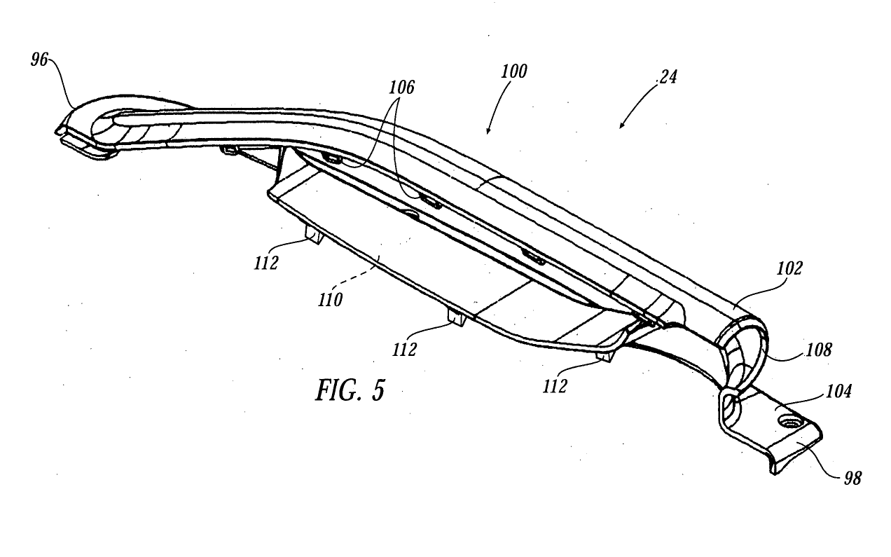

Referring now to FIG. 5, cover 24 is illustrated to include a first end 96 and a second end 98 with a body 100 extending therebetween. The body 100 is defined by a contoured outer surface 102, a base portion 104, a plurality of tab receptacles 106, a side bar surface mating portion 108, and a support mating surface 110. Support tabs 112 extend from support mating surface 110. As illustrated, support tabs 112 are beveled as they extend away from support mating surface 110 such that the thickness of support tab 112 is greater adjacent support mating surface 110. While tabs 80 are described as extending from support flange 22, and tab receptacles 106 are described as being formed in cover 24, tabs and 80 and tab receptacles 106 may be interchangeable therebetween.

FIG. 6 illustrates an assembled front stanchion 14 showing the relationship with side bar 12 in greater detail. Side bar 12 is supported by support 20 at cradle 46. One cover tab 80 is shown in locking engagement with one tab receptacle 106 and a fastener 130 is shown interposed through connecting apertures 48 and another fastener 130 is shown interposed through side bar apertures 74. Side bar apertures may have a nut 134 aligned therewith to further secure the fasteners 130 therein, or side bar apertures 74 may be internally threaded. The cover mating surface 52 matingly engages the support mating surface 110. Preferably, fastener 130 is a screw or a bolt, although fastener 130 may be any suitable means for connection.

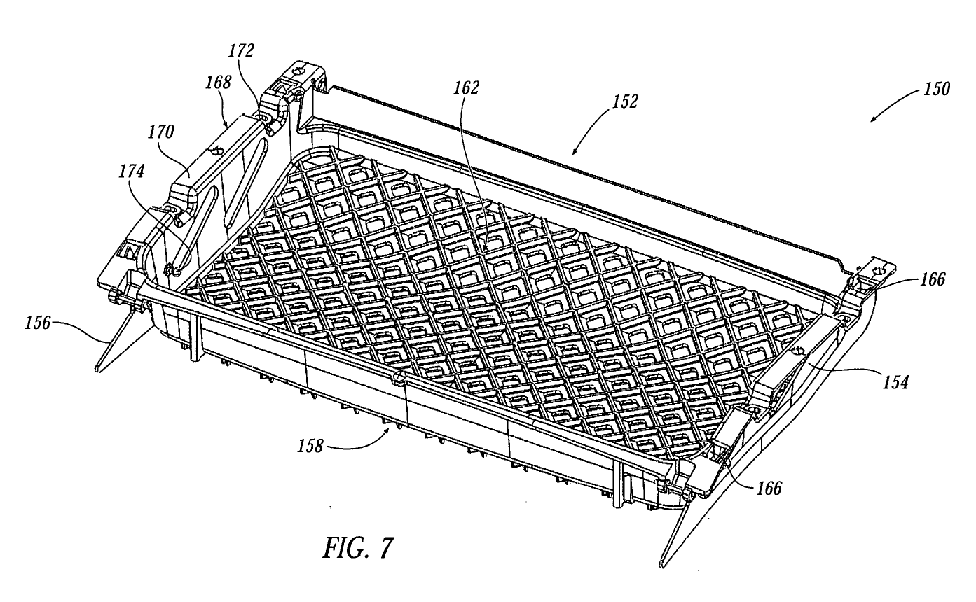

FIGS. 7, 8 and 9 illustrate a typical cross assembly 150 illustrating an embodiment of an attachment interface for mounting cross assembly 150 to front stanchion 14. As illustrated, cross assembly 150 includes a central body 152, a first side 154, a second side 156, a front face 158, a rear face 160, a bottom 162 and a cross cover 164. Central body 152 includes alignment clips 166. Cross assembly 150 preferably includes a storage area defined, at least in part, by central body 150.

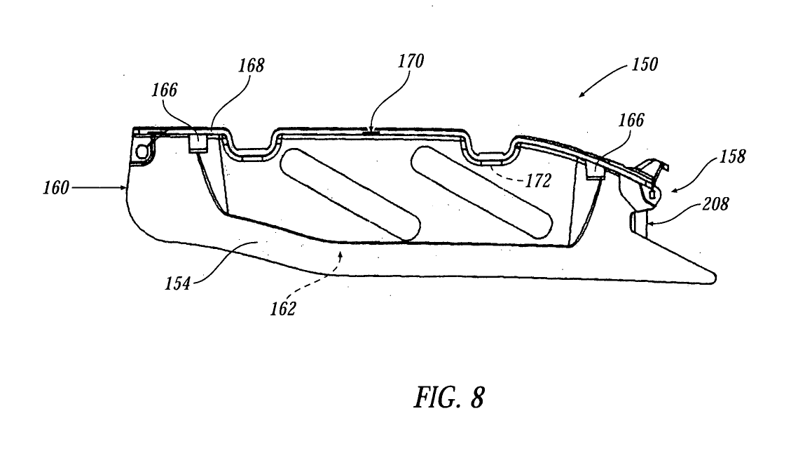

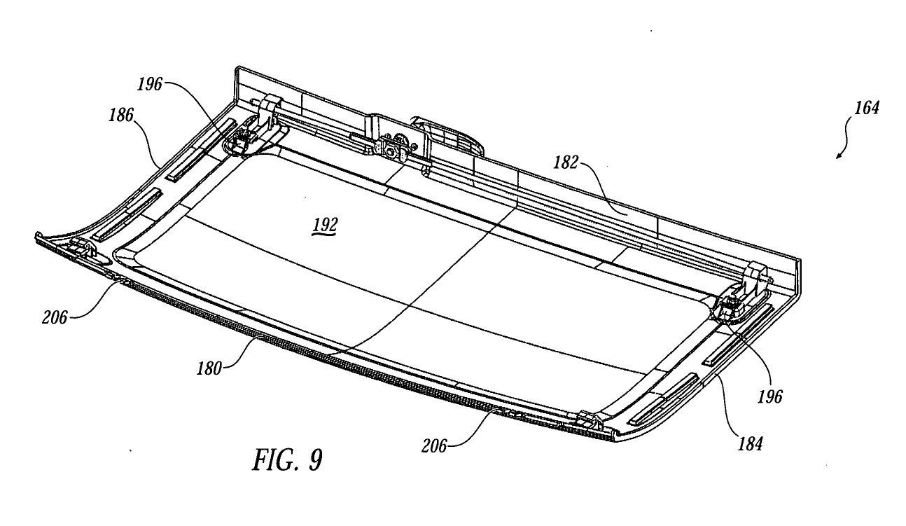

As best seen in FIGS. 7 and 8, the first side 154 includes an attachment flange 168 defined in part by a contoured flange surface 170 and attachment apertures 172. Cross assembly 150 may include a strut mount 174. Cross cover 164 is illustrated in FIG. 9 to include a front end 180, a rear end 182, a first side 184, a second side 186, a top surface 190, and a bottom surface 192. As illustrated, a pair of dog houses 196 attached to the bottom surface 192. A gas strut (not shown) is attached between the dog house 196 and strut mount 174 in order to facilitate the opening of cross cover 164. Generally, first side 154 and second side 156 are symmetrical for coupling to support flanges 22 and mating with side bar assemblies 10.

When a cross assembly 150 is positioned between two front stanchions 14 in accordance with the present invention (one being a mirror image of the other), alignment clips 166 engage the alignment surface locations 82 of support flange 22 and displace inwardly. Thus provided, alignment clips 166 and the alignment surface locations 82 provide a centering assembly to center cross assembly 150 between the front stanchions 14. The centering assemblies provide a generally equal gap between covers 24 and cross cover 164. Centering cross assembly 150 is advantageous to minimize air gaps between the various components of the article rack, thereby providing a more aesthetically pleasing appearance and reducing wind noise during vehicle operation. The centering assemblies align the each cover 24 with one of the first side 184 and the second side 186 of cross cover 164, thus providing an aesthetic appearance. While alignment clips 166 are illustrated as extending from cross assembly 150 and engaging support flanges 22, alignment clips 166 may extend from support flanges 22, or other portions of side bar assemblies 10, to accomplish the purposes described herein.

As best seen in FIG. 9, cross cover 164 includes a pair of clips 206 formed into front end 180. As best seen in FIG. 8, central body 152 includes a pair of contoured posts 208 formed into front face 158. When cross cover 164 is in a fully open position, clips 206 bindingly engage posts 208 to encourage cross cover 164 to remain in the fully open position. Cross assembly 150 may include the clip 206 post 208 arrangement or gas struts 200 to retain cross cover in an open position when a user is accessing the interior of central body 152.

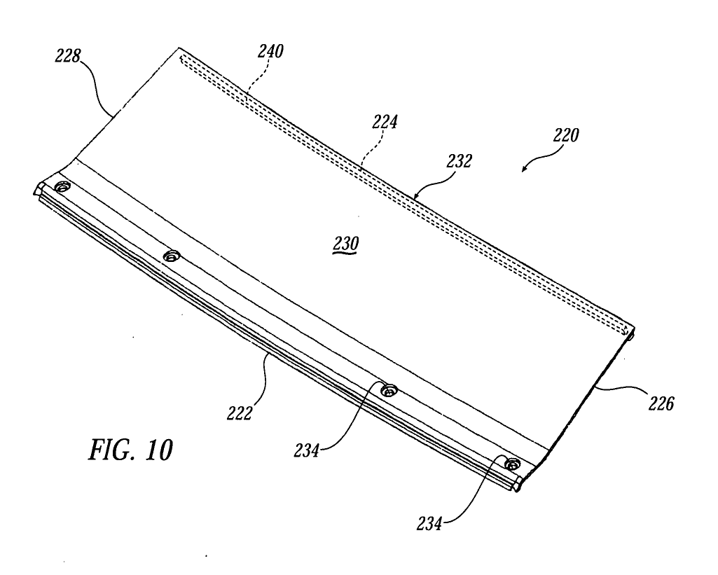

FIG. 10 illustrates an air dam 220. Air dam 220 includes a forward end 222 a rearward end 224, a first side 226, a second side 228, a bottom surface 230, a top surface 232, and mounting apertures 234. Air dam 220 is also illustrated to include a leveling gasket 240 attached to bottom surface 230, adjacent rearward end 224. When a cross assembly 150 is attached to a pair of side bar assemblies 10 (with one being a mirror image of the other), air dam 220 may be attached to the vehicle using mounting apertures 234, such that first side 226 is adjacent forward end 34 of one front stanchion 14 and second side 228 is adjacent forward end 34 of the opposing front stanchion 14, and rearward end 224 is adjacent front end 180, where leveling gasket 240 is interposed between clips 206 and bottom surface 230. Thus provided, leveling gasket 240 positions air dam 220 in an appropriate orientation with cross cover 164 to ensure a proper flow of air over the article rack. Air dam 220 is aligned with covers 24 of front stanchions 14 due to the contact of bottom surface 230 with front end 66 of support flanges 22. The alignment of air dam 220 and front stanchions 14 includes alignment of contoured outer surfaces 102 with top surface 232.

During assembly of front stanchion 14, curved portion 30 of side bar 12 is positioned within cover 24 such that front stanchion end 26 of side bar 12 terminates within cover 24, and side bar 12 extends past side bar surface mating portion 108. At least a portion of front stanchion end 26 abuts abutting surface 62. Preferably, side bar surface mating portion 108 extends more than 180° around side bar 12 to allow cover 24 to bindingly engage or clip over side bar 12. More preferably, side bar surface mating portion 108 extends around side bar 12 between about 250° and 200°. Even more preferably, side bar surface mating portion 108 extends about 225° around side bar 12. Additionally, other portions of cover 24 in contact with side bar 12 extend slightly more than 180° around side bar 12. In this manner, side bar 12 may be bindingly clipped into frictional engagement with cover 24 as front stanchion 14 is assembled. When cover 24 is bindingly clipped onto side bar 12, assembly is simplified when aligning other components, as discussed below.

Support 20 is then positioned adjacent cover 24 and side bar 12 such that forward end 34 of support 20 and first end 96 of cover 24 are adjacent. Rearward end 36 of support 20 and second end 98 of cover 24 are adjacent such that side bar surface mating portion 60 and side bar surface mating portion 108 encompass a perimeter of side bar 12, as best seen in FIG. 1. The cover mating surface 52 matingly engages the support mating surface 110, as best seen in FIG. 6. Support tabs 112 are interposed within indents 64 as cover mating surface 52 and support mating surface 110 are engaged. In this manner, the alignment of support tabs 112 and indents 64 provide a self-aligning feature for assembly of front stanchion 14.

Support flange 22 is then positioned adjacent cover 24, support 20, and side bar 12 such that side surface 72 abuts side bar 12, and front end 66 is adjacent forward end 34 and first end 96. Fasteners 130 may then be inserted through connecting apertures 48 and attachment apertures 32 to secure support 20 to side bar 12 and threaded into nuts 134, if present (FIG. 6). Cover tabs 80 and tab receptacles 106 are engaged to provide an attachment between support flange 22 and cover 24. In this manner, relative movement between support flange 22 and cover 24 that could result in noise and vibrations due to interference is minimized, and a portion of cover 24 is further secured within front stanchion 14. Flange mount 56 and flange aperture 90 may be attached with a suitable fastener to further secure support flange 22 and support 20 adjacent front end 66 and forward end 34 within front stanchion 14.

Typically, an article rack assembly (not shown) includes a pair of side bar assemblies and various cross assemblies. During assembly of the article rack, a front stanchion 14 is placed adjacent cross assembly 150 such that cross surface 76 of support flange 22 is in contact with contoured flange surface 170. One fastener 130 can then be inserted through one cross aperture 78 and one attachment aperture 172. A complementary stanchion is attached to second side 156 in a similar manner. Thus provided, a cross assembly 150 may be secured to a vehicle. As will be appreciated, various cross assemblies may be employed with side bar assembly 10, such as a cross bar, or no cross assembly may be employed.

As discussed herein, cover 24 and side bar 12 may be releaseably or bindingly clipped together during assembly of front stanchion 14. In this manner, cover 24 and side bar 12 may be held in a desired relative position as either support 20 or support flange 22 is positioned adjacent and coupled to cover 24 and side bar 12, thereby facilitating the assembly of front stanchion 14. As shown in FIG. 1, support flange 22, cover 24 and support 20 matingly engage to form a stable, aesthetic front stanchion 14 for the support of side bar 12.

As best seen in FIG. 1, the first end 96 of cover 24 is mounted toward the front end of a vehicle as the contoured outer surface 102 diverts airflow around side bar assembly 10 during forward vehicle operation. In this manner, front stanchion 14 provides for improved airflow around side bar assembly 10, thereby reducing wind resistance and noise. As will be appreciated, an article rack assembly that includes a pair of side bar assemblies would include a side bar assembly 10, such as illustrated in FIGS. 1-6, and a side bar assembly that is generally a mirror image of side bar assembly 10.

As illustrated herein, the front stanchion 14 is assembled using the support 20, the support flange 22, and the cover 24. An analysis of front stanchion 14 has demonstrated that support flange 22 will experience higher stresses than support 20 and cover 24. In contrast to previous stanchions that were constructed of large components that experience relatively high stresses during normal operation, support flange 22 is a relatively small volume component. Preferably, support flange 22 is constructed of a higher strength material than either support 20 or cover 24. Even more preferably, support flange 22 is constructed of a material that has both a higher tensile strength and a higher yield strength than either support 20 or cover 24. Also preferably, support flange 22 is constructed of a fiber reinforced composite. Front stanchion 14 may be constructed of a support 20 and a cover 24 that utilize a relatively inexpensive composite construction, and a support flange 22 that utilizes a relatively small volume of a more expensive, higher strength composite construction, thereby lowering the overall cost of front stanchion 14 when compared to a construction that utilizes a larger amount of more expensive composites. Thus provided, stanchion 14 includes a support flange 22 that transmits the loadings of a cross assembly 150 to the side bar 12, anchors cover 24 to front stanchion 14, and

Cover tabs 80 and tab receptacles 106 may be any suitable fastener. The cover tabs 80 and tab receptacles 106 may also be interchanged between cover 24 and support flange 22. In addition to the contoured surfaces that mate together in an assembled front stanchion 14, various fasteners 130 (FIG. 6) are used with mounting apertures 44, side bar apertures 74, and cross apertures 78 to completely assemble front stanchion 14.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A stanchion of an article rack assembly for attaching a side bar to a vehicle, comprising:
a support, wherein said support is selectively attached to the vehicle and the side bar;
a cover adjacent said support and the side bar, wherein said cover is selectively adapted to bindingly clip into a desired attachment with the side bar; and
a support flange, wherein said support flange is adjacent the side bar and selectively coupled to said cover, said side bar and a cross assembly, wherein said support flange is constructed of a higher strength material than said support and said cover.

2. The stanchion of claim 1, wherein said support flange has a higher tensile strength than said support.

3. The stanchion of claim 1, wherein said support flange has a higher yield strength than said support.

4. The stanchion of claim 1, wherein said support flange is selectively coupled to said cover with a tab/tab receptacle arrangement.

5. The stanchion of claim 1, wherein said support flange is selectively coupled to said side bar with a fastener.

6. The stanchion of claim 5, wherein said fastener is a screw or a bolt.

7. The stanchion of claim 1, wherein said support is selectively coupled to the side bar with a screw or a bolt.

8. An article rack assembly for a vehicle, comprising:
a side bar;
a support, wherein said support is selectively attached to the vehicle and adjacent said side bar;
a cover adjacent said support and the side bar; and
a support flange, wherein said support flange is adjacent said side bar and selectively attached to said support and to said cover, said support flange is selectively coupled to a cross assembly, said support flange is constructed of a higher strength material than said support, and wherein at least said support, said cover, and said support flange form a stanchion.

9. The assembly of claim 8, wherein said support flange is constructed of a higher strength material than said cover

10. The assembly of claim 8, further comprising a second support coupled to said side bar.

11. The assembly of claim 8, further comprising a rear stanchion coupled to said side bar.

12. The assembly of claim 8, further comprising a second front stanchion coupled to a second side bar.

13. The assembly of claim 8, wherein said cover is selectively adapted to bindingly clip into a desired attachment with said side bar.

14. The assembly of claim 8, further comprising a cross assembly selectively attached to said support flange.

15. The assembly of claim 14, wherein said cross assembly includes an alignment clip to position said cross assembly within said article rack assembly.

16. The assembly of claim 8, wherein said support flange is selectively coupled to said side bar with a fastener.

17. A method of assembling a stanchion for an article rack assembly comprising the steps of:
bindingly clipping a cover to a first end of a side bar, wherein the side bar has a bend adjacent the first end and the cover contacts at least more than 180° of a cross section of the side bar;
positioning the cover and the side bar adjacent a support, wherein the support is selectively coupled to the side bar; and
coupling a support flange to the side bar.

18. The method of claim 17, wherein said step of coupling the support flange to the side bar includes installing a bolt or a screw.

19. The method of claim 17, wherein the support flange has a higher tensile strength than the support.

20. The method of claim 17, further comprising the step of coupling the cover to the support.

21. A stanchion of an article rack assembly for attaching a side bar to a vehicle, comprising:
a support, wherein said support is selectively attached to the vehicle and the side bar;
a support flange, wherein said support flange is adjacent the side bar and selectively coupled to said side bar and a cross assembly; and
a centering assembly, wherein said centering assembly selectively aligns at least a portion of the cross assembly with at least a portion of said stanchion.

22. An article rack assembly for a vehicle, comprising:
a side bar;
a first support, wherein said first support is selectively attached to the vehicle and adjacent said side bar, and said first support forms at least a portion of a stanchion;
a support flange, wherein said support flange is adjacent said side bar and selectively attached to said first support and to said cover;
a cross assembly; and
an air dam, wherein said support flange is selectively coupled to said cross assembly and at least a portion of said support flange selectively aligns at least a portion of the cross assembly with at least a portion of said stanchion.

23. The article rack assembly of claim 22, further comprising a second support, wherein said support flange selectively centers at least a portion of the cross assembly generally between said first stanchion and said second stanchion.
